(19) United States
(12) Patent Application Publication
(10) Pub. No.: US 2006/0245618 A1
(43) Pub. Date: Nov. 2, 2006

(54) Motion detection in a video stream

(75) Inventors: Lokesh R. Boregowda, Bangalore (IN); Mohamed M. Ibrahim, Kayalpatnam (IN); Mayur D. Jain, Akola (IN); Venkatagiri S. Rao, Bangalore (IN)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 11/223,177

(22) Filed: Sep. 9, 2005

(30) Foreign Application Priority Data
Apr. 29, 2005 (IN) 1061/DEL/2005

(51) Int. Cl. G06K 9/00

(52) U.S. Cl. 382/107

(57) ABSTRACT

A moving object is detected in a video data stream by extracting color information to estimate regions of motion in two or more sequential video frames, extracting edge information to estimate object shape of the moving object in two or more sequential video frames; and combining the color information and edge information to estimate motion of the object.

### CROSS REFERENCE TO RELATED APPLICATIONS

This application claims priority to India Patent Application No. 1061/DEL/2005, filed Apr. 29, 2005, which is incorporated herein by reference.

### FIELD OF THE INVENTION

The invention relates generally to analyzing video data, and more specifically to motion detection using background image processing for video data.

### BACKGROUND

Video cameras are commonly employed in security and monitoring systems, providing a user the ability to monitor a wide variety of locations or locations that are physically remote from the user. The video cameras are often also coupled to a video recorder that records periodic images from the video camera, or that records video upon detection of motion. Such systems enable a user to monitor a location in real-time, but also enable a user to review events that occurred at a monitored location after an event, such as after a burglary or to confirm some other event.

Monitoring a large number of cameras requires a large number of monitors, and a number of guards sufficient to keep an eye on each monitor. Simply employing more monitors and more guards in large facilities such as manufacturing plants, military bases, and other large environments is not a desirable solution because of the additional cost involved, and so automated solutions to monitoring a number of video signals for events have been explored.

One technology commonly used to automatically monitor video signals for activity is use of a motion detection algorithm to detect when one or more objects in the video signal are moving relative to a background. Such systems can be used to monitor for intrusion or unauthorized activity in the field of a variety of video cameras, and alert a user upon detection of motion in the video stream. For example, such a system may monitor twenty video streams for motion, and upon detection of motion in one of the video streams will sound an alarm and display the video signal with detected motion on a video display.

The reliability and accuracy of video motion detection is therefore important to ensure that such systems provide adequate security, and can be relied upon to monitor video signals for unauthorized activity in place of human security personnel. False detections of motion should therefore be kept to a minimum to ensure that detected motion events justify attention and intervention of security personnel. Further, the detection probability should be as high as possible, to ensure that unauthorized motion events do not go undetected. The motion detection system should further be insensitive to environmental variations such as snow, rain, and cloudy weather, and should work in a variety of lighting conditions. Accurate motion detection is also important in systems in which motion detection is a part of a more sophisticated process such as object tracking or identification and video compression.

It is therefore desirable that video signal motion detection be as accurate as is technically practical.

### BRIEF DESCRIPTION OF THE FIGURES

FIG. 1 is a flowchart illustrating learning a background image for video motion detection, consistent with an example embodiment of the invention.

FIG. 2 is a flowchart illustrating a video motion detection algorithm consistent with an example embodiment of the invention.

FIG. 3 is a flowchart illustrating generation of an edge strength image, consistent with an example embodiment of the invention.

FIG. 4 is a flowchart illustrating combination of edge strength image data and binary image data, consistent with an example embodiment of the invention.

FIG. 5 is a flowchart illustrating a method of updating a background image, consistent with an example embodiment of the invention.

FIG. 6 is a flowchart illustrating combination of color and edge information to estimate motion in a video stream, consistent with an example embodiment of the invention.

FIG. 7 is a flowchart illustrating finding an edge of a moving object in a video stream, consistent with an example embodiment of the invention.

FIG. 8 is a flowchart illustrating application of a color/luminance motion detection algorithm to video motion detection, consistent with an example embodiment of the invention.

### DETAILED DESCRIPTION

In the following detailed description of example embodiments of the invention, reference is made to specific examples by way of drawings and illustrations. These examples are described in sufficient detail to enable those skilled in the art to practice the invention, and serve to illustrate how the invention may be applied to various purposes or embodiments. Other embodiments of the invention exist and are within the scope of the invention, and logical, mechanical, electrical, and other changes may be made without departing from the subject or scope of the present invention. Features or limitations of various embodiments of the invention described herein, however essential to the example embodiments in which they are incorporated, do not limit the invention as a whole, and any reference to the invention, its elements, operation, and application do not limit the invention as a whole but serve only to define these example embodiments. The following detailed description does not, therefore, limit the scope of the invention, which is defined only by the appended claims.

In one example embodiment of the invention, a moving object is detected in a video data stream by extracting color information to estimate regions of motion in two or more sequential video frames, extracting edge information to estimate object shape of the moving object in two or more sequential video frames; and combining the color information and edge information to estimate motion of the object.

Detection of moving objects is an important part of video camera based surveillance applications. Many examples of video motion detection algorithms employ background subtraction to detect any activity or motion in the scene. Therefore, it is desirable to first learn the static background scene that does not contain any moving foreground objects. If there are foreground objects that are moving continuously in the scene, then it becomes a problem to identify and learn the static background scene. Various embodiments of the present invention address this problem, such that the learnt background can be used to implement subsequent motion detection algorithms. In fact, the same method can be applied to continuously update the background, once the initial learning phase is completed.

In one example, instead of using conventional image subtraction approach for motion detection, the current image is divided by the sum of current image and learnt background image to generate a division image. The division image is subjected to a threshold operation to get the motion detected image. Further robustness is achieved by combining the motion detected image with the edge strength image. The method is described below.

In the first step, the color image obtained from the camera is converted into a grayscale image and the resulting gray level image is passed through an averaging filter such as a 3×3 neighborhood averaging filter to reduce the effect of noise. This filtered image is referred to as current image in the subsequent discussions. The second step involves learning the static background scene, and for this purpose the current image and the image which was captured five frames earlier are used. The algorithm is designed to pick up only static background pixels and reject those pixels which correspond to moving objects in the foreground. In the third step, this learned background image along with the current image are utilized to generate a division image. In the fourth step, the division image is subjected to a threshold operation to get a segmented binary image wherein all the background pixels are set to zero and the moving foreground pixels are set to 255. The fifth step involves generating edge strength image for both division image and the current image. The sixth step involves finding the correspondence between the binary image and the edge strength image. The output from this step is subjected to median filtering in the seventh step to get final segmented binary image output. The eighth step involves subsequent updating the background pixels using the current image and the image that was captured five frames earlier. Further details of individual steps in one specific example embodiment are given below.

### Background Learning Mechanism

The background learning used in the example video motion detection algorithm, works as follows. When we monitor a given scene over a period of time, any object which is moving would normally result in considerable change in gray level at those pixel locations, whereas in the areas where there is no activity or motion, gray level value of the pixels remains almost same. To monitor this change in gray levels, we have considered difference image and sum image that are obtained using the current image and old image (5 frames old), and the difference image is thresholded using a scaled version of sum image. This method of thresholding has been found to be robust to change in illumination levels of the scene. Those pixels in the difference image that are below the threshold are considered as background pixels and hence the pixels in the corresponding locations of the current image are learnt as background pixels. In the next video frame, the pixels which are not learnt earlier are only considered and the process is repeated over a number of frames until the entire image is learnt as background. Once the background is fully learnt the algorithm declares that the background is learnt and it switches to a video motion detection (VMD) routine.

If the gray level value at a given pixel location is fn(p,q) at time t, and fn-5(p,q) at time t−5 (five frames earlier), the sum and difference images are obtained as follows.
Difference image: Dif_img=abs(fn−fn-5) (1)
Sum image: Sum_img=(fn+fn−5) (2)
Threshold_img=k1*Sum_img (3)
k1=Constant multiplying factor which decides the gray level variation between the two video frames that can be allowed to qualify a given pixel as a background pixel or not. It is chosen in the range of 0.0001 to 0.001.

The value of each and every pixel in the Dif_img is compared with a corresponding pixel in the Threshold_img and if a given pixel is less than the Threshold_img value, it is considered as static background pixel.

If Dif_img(p,q) < Threshold_img(p,q)
Bg_img(p,q) = fn(p,q)

Where Bg_img(p,q) is the learnt background image pixel, ‘p’ indicates row and ‘q’ indicates column number.

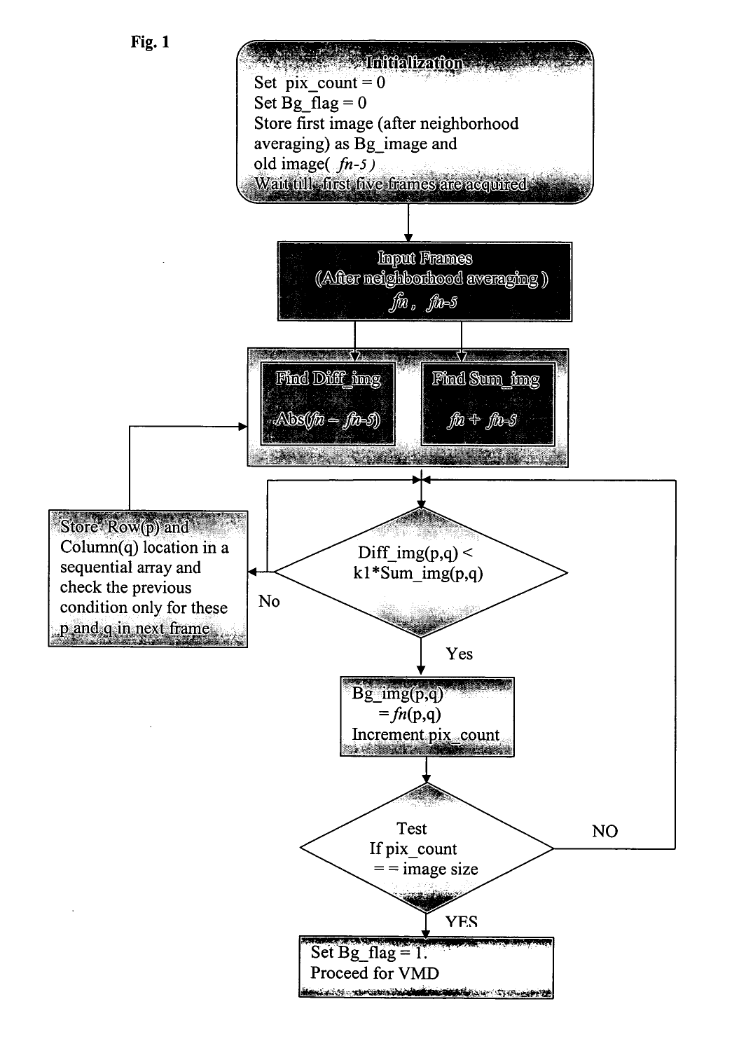

The location (row ‘p’ & column ‘q’) of all the pixels which do not satisfy the above condition is stored in a sequential array. In the next frame, only those pixels which are available in the sequential array are tested for the above(If) condition and the process is repeated in every frame till the number of learnt background pixels is same as the image size. Then it declares that the background is learnt. This learnt background image is use in the subsequent Video Motion Detection algorithm. FIG. 1 shows a flowchart of one example method of learning a background image, consistent with the example embodiment of the invention described above.

### Video Motion Detection

For motion detection, the current image is typically subtracted from the background image, and the background subtracted image is evaluated using a threshold to extract all the moving foreground pixels. In some embodiments of the present invetntion, we normalize the current image by dividing it with the sum of current image and the background image and the resulting division image (Div_img) is used for extracting the moving foreground pixels from the static background pixels.
Div_img=fn/(Bg_img+fn) (4)

To segment this division image into background and moving foreground pixels (target pixel), it is desired to subject the image to a thresholding operation. It is evident from the above equation (Equation No. 4) that all those pixels in the current image (fn) which are equal to the corresponding pixels in the background image (Bg_img) would yield a value of 0.5 in the Div_img; whereas all target pixels show up as deviations on either side of this mean value (0.5). However, it is advisable to find this mean value from the image itself as there could be variations in light levels from frame to frame. Hence, the mean gray level of the division image (Div_img) was first determined. While finding the mean, those pixels that are in the neighborhood of 0.5 (0.4 to 0.6 range) were only considered. After getting the mean gray level value of the division image, it is multiplied by two different constants (k2 and k3) to generate lower and upper threshold as indicated below.
High threshold=k2*mean_Div_img (5)
Low_threshold=k3*mean_Div_img (6)

In our implementation, the value of k2 and k3 are chosen as 1.1 and 0.9 respectively, assuming a ±10% spread around the mean for background pixels. This assumption proved to be a valid one when tested on a variety of video data sets. Alternatively, the values of k2 and k3 can be chosen by computing the standard deviation of those pixel gray levels that are used for finding the mean value. The lower threshold operates on those object pixels that are darker than the background and the higher threshold operates on the object pixels that are brighter than the background.

Segmentation of image into background and target regions is done by comparing each and every pixel with high and low thresholds as per the logic given below.

```
If  [ Div_img(p,q) < Low_threshold OR Div_img(p,q) >
High_threshold ]
                    Bin_img(p,q) = 255;
  Else  Bin_img(p,q) = 0;
```

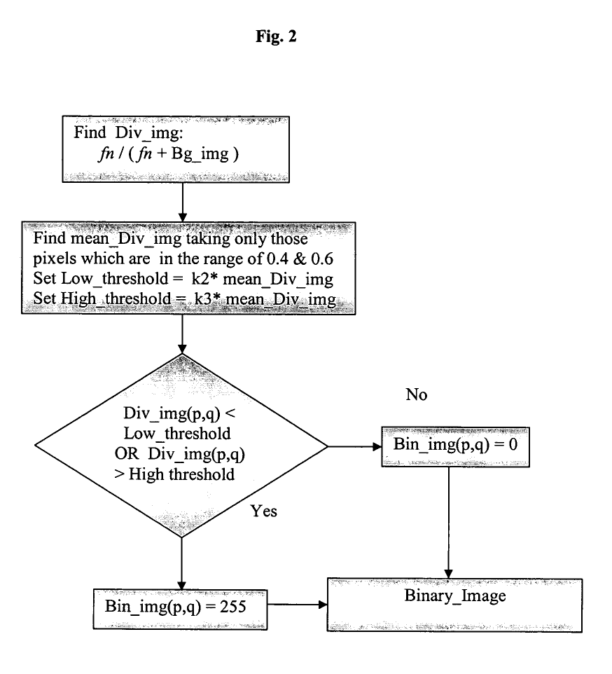

Bin_img is the segmented binary image, wherein all pixels indicating 255 correspond to moving foreground pixels and pixels with zero values correspond to background region. The flowchart of the VMD algorithm is given in FIG. 2.

### Generation of Edge Strength Image

If an object that is learned as background earlier starts moving, then it shows up as two objects; one at the new location and one at the location where it was residing earlier. This happens because it takes a certain amount of time to learn the exposed background area where object was residing earlier. This problem can be avoided if we somehow combine the current edge image with the binary image output of motion detection routine. This is done by first extracting the edge strength image which is common to both division image and the current image. The actual procedure involves finding the row difference and column difference image and combining both as explained below.
Find gray_image_rowdiff(p,q)=gray_image_ro(p+1,q)−gray_image_ro(p,q); for all the rows over the entire image.
Find gray_image_coldiff(p,q)=gray_image_col(p,q+1)−gray_image_col(p,q); for all the columns over the entire image.
Find Edge_Strength_Current_Image(p,q)=Sqrt[(gray_image_rowdiff(p,q))ˆ2+(gray_image_coldiff(p,q))ˆ2]
Where p,q are the row and the column indices of a given pixel in the image under consideration.

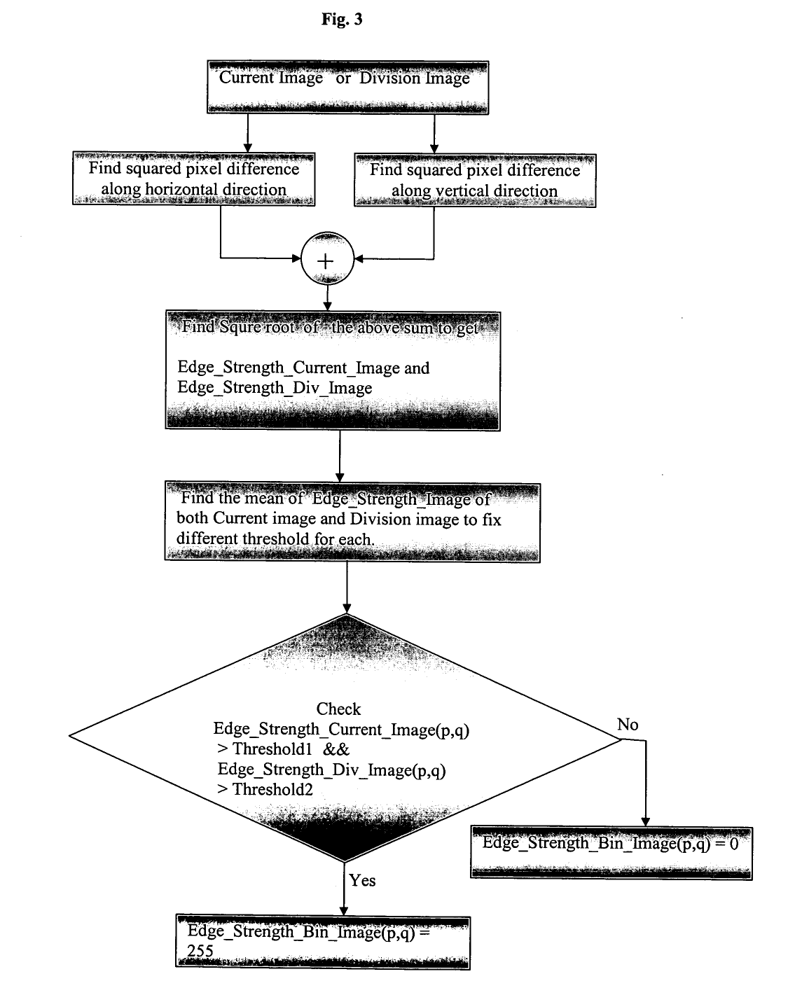

Similarly Edge_Strength_Div_Image is also obtained for division image. After this step, mean grey level of Edge_Strength_Current_Image and Edge_Strength_Div_Image are separately determined to compute separate thresholds for both the edge strength images. Let us call Thr1 and Thr2 as thresholds for Edge_Strength_Current_Image and Edge_Strength_Div_Image respectively. Using these two thresholds simultaneously, a single Binary_Edge_Image is obtained using the following logic.

| If ( Edge_Strength_Current_Image(p,q) > Thr1 && | |
|---|---|
| Edge_Strength_Div_Image(p,q) > Thr2 ) | |
| | Binary_Edge_Image(p,q) = 255 |
| Else | Binary_Edge_Image(p,q) = 0 |

Where p,q are the row and the column indices of a given pixel in the image under consideration. The flowchart of FIG. 3 illustrates this method of generation of an edge strength image.

### Combining Edge_Strength_Binary_Image with the Motion Detected Binary Image

To eliminate spurious pixels in VMD output, the correspondence between the edge strength image and the VMD output (binary blobs) is established using three “If Else” loops as explained below. For this, the VMD binary image and the edge strength image are scanned from left to right along top to bottom direction row by row. Initially a flag known as Start_flag is set to zero and the VMD output is copied into two arrays known as Bin_img1 and Bin_img2.

```
Start_flag = 0;
Bin_img1 = Bin_img;
Bin_img2 = Bin_img;
If (( Bin_img1(i,j) + Edge_img(i,j) == 510 ) & (Start_flag == 0 ))
  Start_flag = 1;
Else
End;
If (Start_flag == 0) & (Bin_img1(i,j) == 255)
        Bin_img1(i,j) =0;
Else
End;
If ( Start_flag == 1) & ( Bin_img1(i,j) + Edge_img(i,j) == 0)
  Start_flag = 0;
Else
End;
```

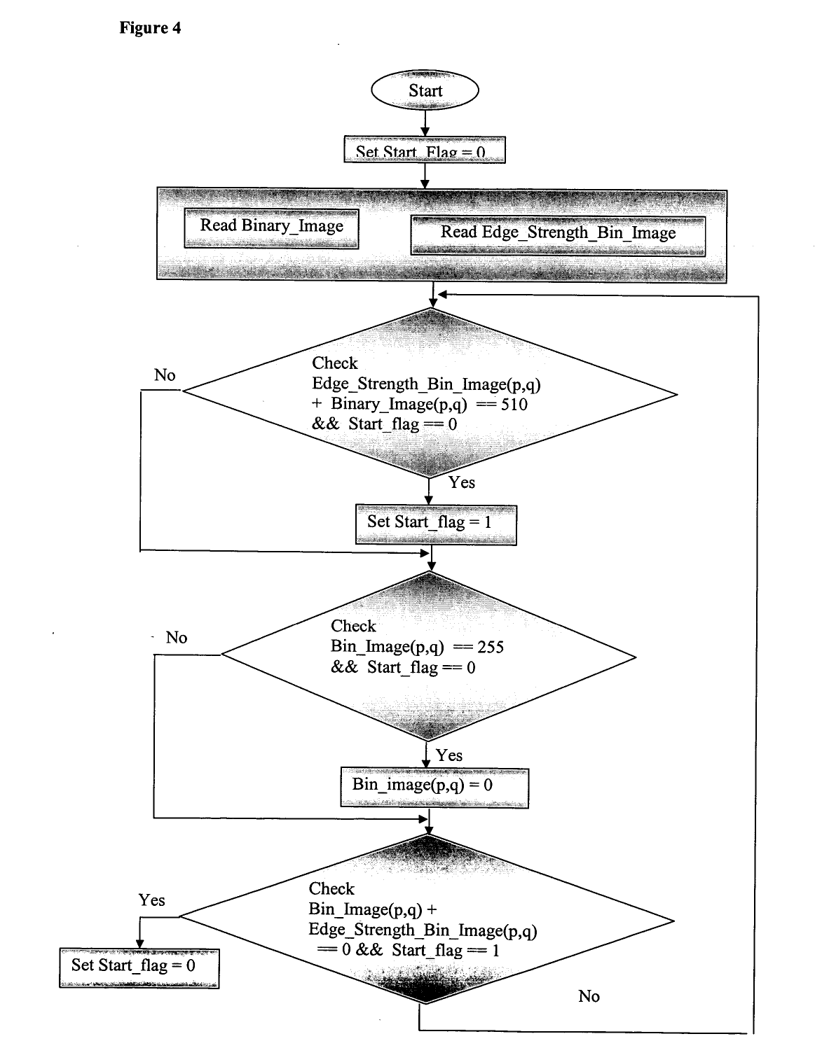

Start_flag is set to zero at the beginning of each and every row before applying the “If, Else” condition. i,j are the row and column indices of a given pixel in the images under consideration. Similarly, Bin_img is modified by traversing in the right to left direction. Afterwards, final binary image is obtained by doing an “OR” operation on the two binary images. Bin_img=Bin_img1 OR Bin_img2. This method of combining the edge strength image data and binary image data is illustrated in FIG. 4.

### Background Update

There is a need to update the learned background scene as one cannot be sure of some image characteristics such as the same level of illumination over an extended period of time. Also, an object that was stationary during the learning period may start moving at a later time or a new object may enter the camera field of view and remain stationary for a long period. Under such circumstances, it is desired to update the learnt background scene to have effective motion detection. The procedure adapted for updating the background is given below.

Similar to the initial learning of background, the current image (fn) and the image which is five frames old (fn−5) are used to obtain Diff_img and Sum_img( Equations 1&2). If a given pixel in the Diff_img satisfies the following inequality condition, then the previous background image at that location is replaced by the weighted sum of present image and the previous background image.

If Diff_img(p,q) < k1 * Sum_img(p,q)
Bg_img(p,q) = α*fn(p,q) + (1−α)*Bg_img(p,q) ---- ( 7 )

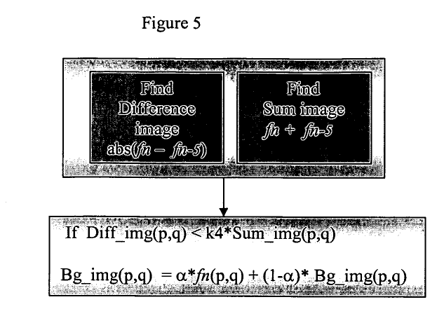

α=Learning rate for the background pixels. The value of α can be varied between ‘zero’ and ‘one’ depending on the required learning rate. k1=Constant multiplying factor as chosen in the earlier background learning routine (Equation. 1). This updated Bg_img is used in the next frame to obtain the Div_img in the VMD routine and the whole process repeats. This method is shown in flowchart form in FIG. 5.

The method described above is an example embodiment of the present invention illustrating how extraction of various information from a video stream can be used to effectively detect motion for applications such as security monitoring and object identification.

### A Second Algorithm Example

In another example, color and edge information are extracted from the video frame sequence to estimate motion of an object in a video stream. The color information is used as the first level cue to extract motion regions. These motion regions/blobs usually do not account for the full shape & contour of the moving object. The incomplete blobs thus obtained from the color model, are boosted by second level processing using the edge information. The final motion segmented result is then obtained as the collated information of the color and edge foreground confidence maps.

This second video motion detection algorithm involves the generation of the mean and variance images (computed pixel-wise) based on the color & edge information of each of the frames in the video data. These mean and variance images are then updated dynamically using the method of moments to help build the color & edge models respectively. The models basically learn the background information in the frames. These models are then threshold-ed using standard deviation information to conclude whether a pixel belongs to the foreground (FGND) or background (BGND) leading to the formation of motion confidence map. The algorithm flow for the color (or Luminance) and edge based analysis is described in the flow diagram shown below. The method starts with the computation of the mean and difference images for the current frame at each pixel as given by the equations,
Y₍ₙ₎(x,y)=0.299R₍ₙ₎(x,y)+0.587G₍ₙ₎(x,y)+0.114B₍ₙ₎(x,y) (11)
μ₍ₙ₎(x,y)=α_{avg}Y₍ₙ₎(x,y)+(1−α_{avg})μ₍ₙ₋₁)(x,y) (12)
ΔC=Y₍ₙ₎(x,y)−μ₍ₙ₎(x,y) (13)
Where,
n=nth frame
Y₍ₙ₎(x,y)=Luminance
G₍ₙ₎(x,y)=Green pixel
μ₍ₙ₎(x,y)=pixel mean at position x,y
ΔC=mean difference Image
R₍ₙ₎(x,y)=Red pixel
B₍ₙ₎(x,y)=Blue pixel
α_{avg}=Learning parameter
Adaptive threshold computed using the current frame and previous frame difference and the mean of the difference as given below

$$α = {\sum }_{x = 0}^{r} {\sum }_{y = 0}^{c} \vert {Y}_{( n )} ( x , y ) - {Y}_{( n - 1 )} ( x , y ) \vert / {\sum }_{x = 0}^{r} {\sum }_{y = 0}^{c} {Y}_{( n )} ( x , y ) \qquad ( 14 )$$

Where,
r=rows, c=columns
   The average alpha over the frames is used for background model update
   α_{avg}=(α_{avg}+α)/2 (15)

The value of ‘Alpha’ is normalized based on the count of the motion pixels only. The variation of thus computed ‘Alpha’ is shown in the plot shown above and varies most appropriately according to the extent of the motion in the frame. Whenever fast moving objects/slow moving objects are encountered, alpha increases or decreases respectively for the most optimal update of the BGND.

### Background Learning Mechanism

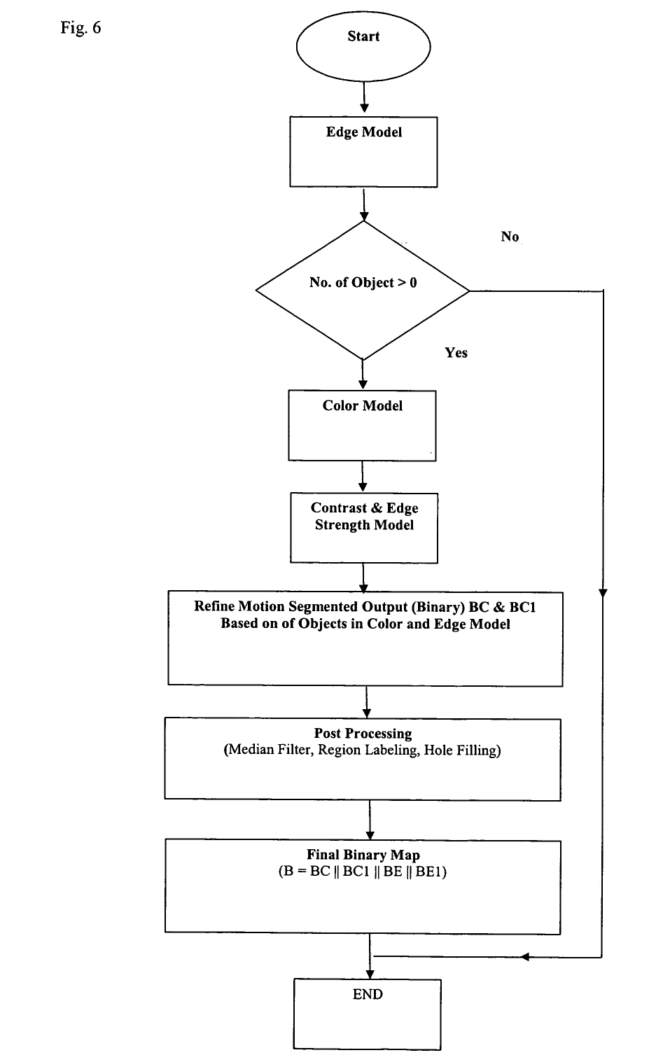

The background learning which forms the backbone of the second example algorithm is based on a hierarchical fusion of a) color and b) edge models obtained corresponding to the pixel-state using its RGB color & Edge information as shown in the flowchart of FIG. 6.

### Edge Model

The color model does not give the smooth edge. To get the fine edge of the object to improve the result, edge model is applied to Y channel as given below. An edge sharpening filter is first applied on the Y channel image data.
Y→EdgeFilter (EF)→X

Output X obtained after passing through the high pass filter is fed to Sobel filter to get the horizontal and vertical edges. The mean and the zero mean are computed for the each channel as
μ_{SH(n)}(x,y)=α_{Edge}S_{H(n)}(x,y)+(1−α_{Edge})μ_{SH(n)}(x,y) (16)
μ_{SV(n)}(x,y)=α_{Edge}S_{V(n)}(x,y)+(1−α_{Edge})μ_{SV(n)}(x,y) (17)
Where,
S_{H}(x,y)=Sobel Horizontal edge data
S_{H}(x,y)=Sobel vertical edge data
μ_{SH(n)}(x,y)=Sobel Horizontal mean
μ_{SV(n)}(x,y)=Sobel Vertical mean
α_{Edge}=Constant

The mean and delta gradient images are computed for the horizontal and vertical Sobel image as below

Mean gradient
Δ1=|μ_{SH(n)}(x,y)−S_{H(n)}(x,y)| (18)
Δ2=|μ_{SV(n)}(x,y)−S_{V(n)}(x,y)| (19)
Delta Gradient
Δ12=|Δ1−Δ2| (20)
Δ=|Δ1+Δ2−Δ12| (21)
Binary Edge segmentation map is obtained using the fixed threshold as given below
Binary Edge Confidence Map (BE)

$${BE}_{( n )} ( x , y ) = \begin{matrix}1 & Δ \geq thr \\ 0 & Otherwise\end{matrix}$$

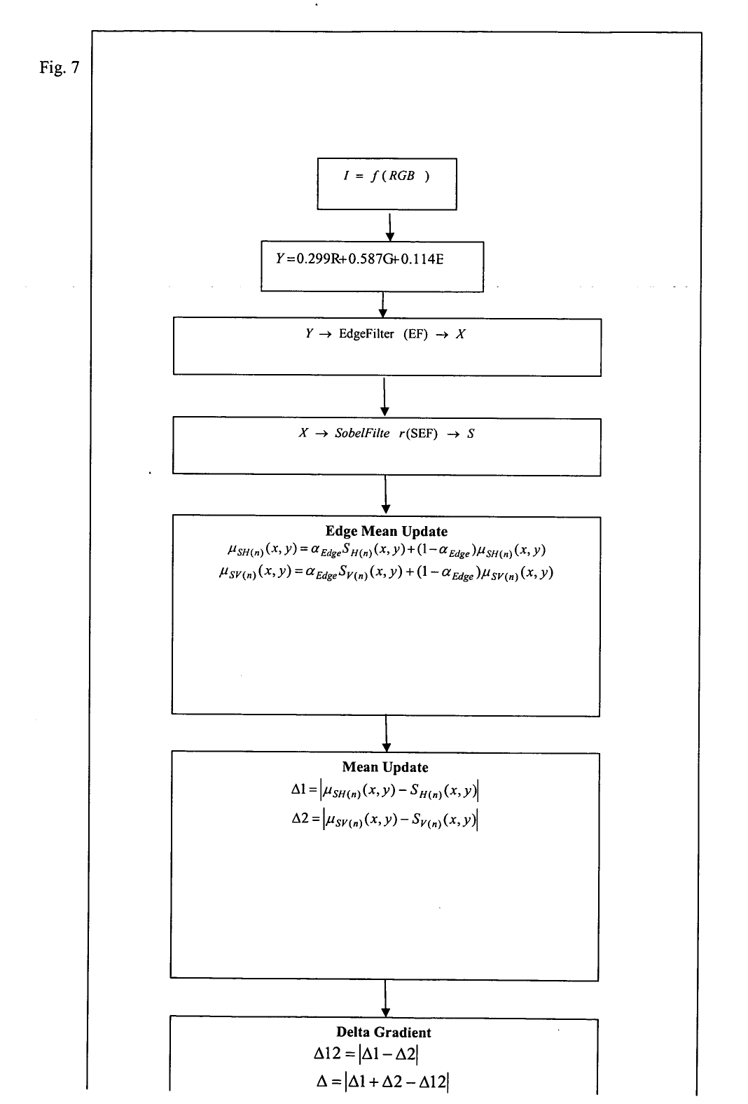

Morphological operators are then applied on the edge map. The overall flow of the Edge model is shown in the flowchart of FIG. 7.

### Color/Luminance Model

For Luminance(Y) channel, background model is build using the weighted sum of mean and the current pixel value
μ₍ₙ₎(x,y)=α_{avg}Y₍ₙ₎(x,y)+(1−α_{avg})μ₍ₙ₋₁₎(x,y) (22)
A difference mean image is computed which is used to threshold and segment the image as foreground or background
ΔC=Y₍ₙ₎(x,y)−μ₍ₙ₎(x,y) (23)
Binary Color Confidence Map (BC)

$${BC}_{( n )} ( x , y ) = \begin{matrix}1 & Δ C \geq 1 / {α}_{avg} & Foreground \\ 0 & Otherwise & Background\end{matrix}$$

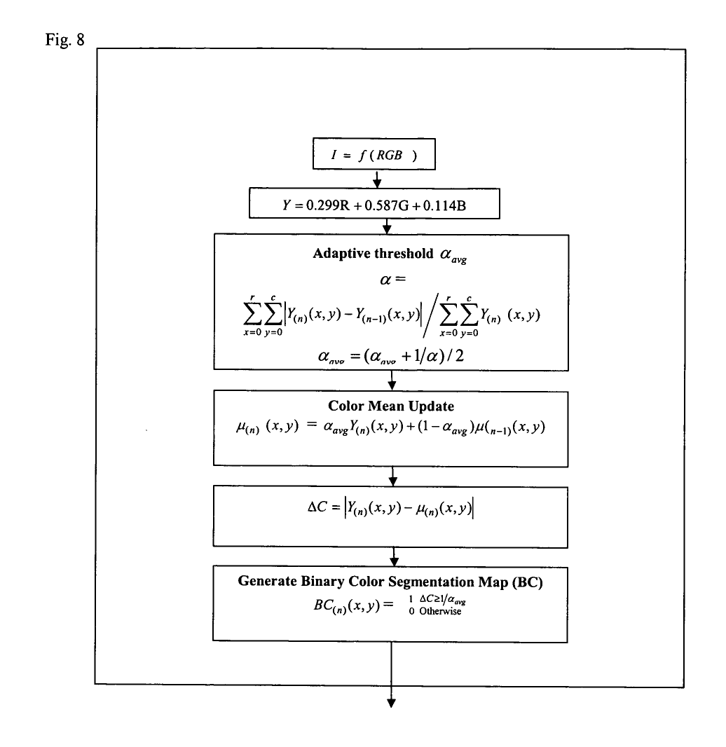

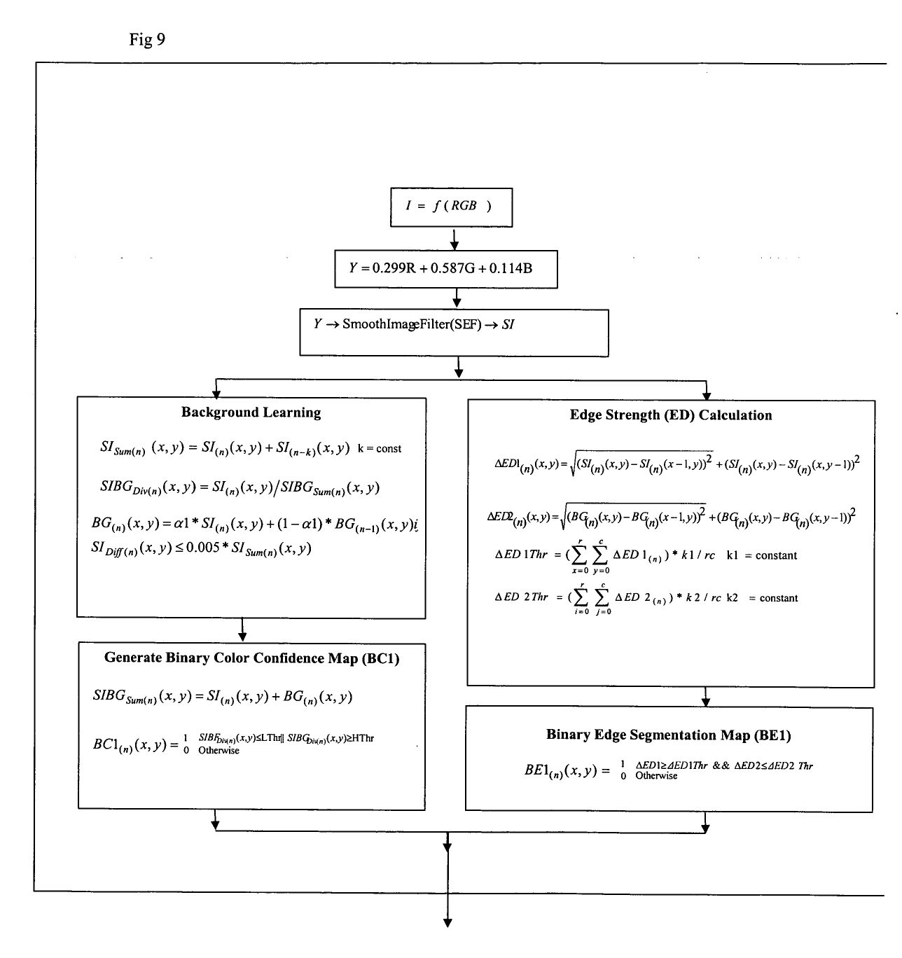

The color/luminance model evaluation process is further summarized in the flowchart of FIG. 8.

### Contrast Model

The images are initially subjected to a pre-processing step, wherein RGB to Gray (intensity or luminance) conversion is carried out, and this image is passed through an averaging (3×3 neighborhood averaging) filter. The averaging filter smooth-en the image and helps in reducing the effect of noise.

If the gray level value at a given pixel location is fₙ(x,y) at time t, and f₍ₙ₋₅₎(x, y) at time t−5 (five frames earlier), the sum and difference images are obtained as follows.
Difference image: Diff_Image=abs(fₙ(x,y)−f₍ₙ₋₅₎(x,y)) (24)
Sum image: Sum_Image=fₙ(x,y)+f₍ₙ₋₅₎(x,y) (25)
Threshold_Image=k1*Sum_Image (26)
Where, Constant k1=Multiplying factor, which decides the gray level variation between the two video frames that can be allowed to qualify a given pixel as a background pixel or not. It is chosen in the range of 0.0001 to 0.001.

The value of each and every pixel in the Diff_Image is compared with a corresponding pixel in the Threshold_Image and if a given pixel is less than the Threshold_Image value, it is considered as static background pixel.

If Diff_Image(x, y) < Threshold_Image(x, y) ,
Bgnd_Image(x, y) = fₙ(x, y) ---- ( 27a )

Where,
Bgnd_Image(x,y) is the learnt background image pixel, ‘x’ indicates columns & ‘y’ indicates rows.

The location(x,y) of all the pixels which do not satisfy the above condition is stored in a sequential array. In the next frame, only those pixels that are available in the sequential array are tested for the above “If” condition and the process is repeated in every frame till the number of learnt background pixels is same as the image size.

To avoid the appearance of artifacts occurring due to illumination changes during the process of learning, after the above mentioned threshold comparison step (17a), the following steps are carried out in every frame using the above Diff_Image, Sum_Image, Threshold_Image and Bgnd_Image.

If Diff_Image(x, y) < Threshold_Image(x, y)
Bgnd_Image(x, y) = α* Bgnd_Image(x, y) + (1−α)* fₙ(x, y) ---(27b)

The value of ‘α’ is chosen as 0.9.

Above analysis until the step-17a is used during the initial background learning phase of the algorithm and if the number of learned background pixels is same or comparable to the image size, the algorithm sets the flag indicating completion of learning process. Further to this, the same steps until the step-17a along with the step-17b together perform moving object segmentation. The procedure adapted for updating the background is described below.

Similar to the initial learning of background, the current image (fₙ) and the image which is five frames old (f₍ₙ₋₅₎) are used to obtain Diff_Image and Sum_Image (Equations 14 & 15). If a given pixel in the Diff_Image satisfies the following inequality condition, then the previous background image at that location is replaced by the weighted sum of present image and the previous background image.

If Diff_Image (x, y) < k1 * Sum_Image (x, y)
Bgnd_Image(x, y) = α* Bgnd_Image(x, y) + (1−α)* fₙ(x, y) ---- ( 28 )

α=Learning rate. Value of α can be varied between ‘zero’ & ‘one’ depending on required learning rate. Where, Constant k1=Multiplying factor as chosen in the earlier background learning routine (Eqn. 14). This updated Bgnd_Image is used in the next frame to obtain the Div_Image in the VMD routine and the whole process repeats.

### Edge Strength Model

The procedure involves computing the row difference and column difference images and combining both as detailed below. Compute the Row and Column difference images respectively as,
Gray_Image_Coldiff(x, y)=fₙ(x+1, y)−fₙ(x, y) (29)
Gray_Image_Rowdiff(x, y)=fₙ(x, y+1)−fₙ(x, y) (30)
Then compute the edge strength image as,
Edge_Strength_Current_Image(x,y)=Sqrt[(Gray_Image_Coldiff(x, y))ˆ2+(Gray_Image_Rowdiff(x, y))ˆ2] (31)
Where x, y are the column and row indices of a given pixel in the image under consideration.

Similarly Edge_Strength_Div_Image is also obtained for division image. After this step, mean grey level of Edge_Strength_Current_Image and Edge_Strength_Div_Image are separately determined to compute separate thresholds for both the edge strength images. Let us call Threshold1 and Threshold2 as thresholds for Edge_Strength_Current_Image and Edge_Strength_Div_Image respectively. Using these two thresholds simultaneously, a single Binary_Edge_Image is obtained using the following logic.

```
If [Edge_Strength_Current_Image(x, y) > Threshold1 &&
Edge_Strength_Div_Image(x, y) > Threshold2]
        Binary_Edge_Image(x, y) = 255
Else
      Binary_Edge_Image(x, y) = 0
```

Where x, y are the row and the column indices of a given pixel in the image under consideration.

### Combining Edge Strength Model Information with Contrast Model Information

To eliminate spurious pixels in video motion detection output, the correspondence between the Edge_Strength_Bin_Image and the video motion detection output (binary blobs) is established in one example embodiment by using three “if-else” loops as explained below. For this operation, the video motion detection binary image and Edge_Image are scanned from left to right along top to bottom direction row by row. Initially a flag known as Start_Flag is set to zero and the video motion detection output is copied into two arrays known as Bin_Image1 and Bin_Image2.

Start Flag 0;

Bin_Image1 = Bin_Image
Bin_Image2 = Bin_Image

If ((Bin_Image1(x, y) + Edge_Image(x, y) == 510) & (Start_Flag == 0))

Start_Flag == 1;

Else

End;

If (Start_Flag == 0) & (Bin_Image1(x, y) == 255)

Bin Image 1(x, y) =0;

Else

End;

If (Start_Flag == 1) & (Bin_Image 1(x, y) + Edge_Image(x, y) == 0)

Start_Flag = 0;

Else

End;

Start_Flag is set to zero at the beginning of each and every row before applying the “if-else” condition. Similarly, Bin_Image2 is modified by traversing in the right to left direction. Afterwards, final binary image is obtained by doing an “OR” operation on the two binary images.
Bin_Image(x, y)=Bin_Image1(x, y) OR Bin_Image2 (x, y)

### Combining the Color & Edge Analysis Results

The motion blobs obtained in the color map BC, BC1 and edge map BE, BE1 are refined using the blob association between the color and edge. Based on the association and consistency the unnecessary blobs will be eliminated and the final output is obtained by OR of all the maps as given below
Final Binary Map: B=BC||BC1||BE||BE1

### Summary of the Second Example Video Motion Detection Algorithm

The second example video motion detection algorithm presented here results in near 100% accuracy for most datasets (except low illuminated scenes) in detecting a moving object. The algorithm extracts complete shape of the moving objects, and has nearly identical performance for slow or fast moving objects, large or small objects, indoor or outdoor environments, and far-field or near-field objects.

Performance also remains stable for relatively low minimum object sizes, on the order of 16 pixels in an outdoor far-field environment, and 150 pixels in an indoor near-field environment. Performance is also stable across video frame capture rates varying from 5 to 15 fps, with low false motion detection on the order of one or two motions per camera per hour in a typical environment, or two to three motions per camera per hour in an environment with a relatively large amount of background change.

Environmental factors such as thick shadows, low illumination or cloud movement, low to moderate wind causing tree motion, low to moderate rainfall, and low to moderate snowfall are all manageable using the example embodiments presented here. Performance remains dependent in part on factors such as separation between moving objects, distinction between moving objects and background regions, and user specified parameters such as minimum object size, regions of interest in the video frame, and other such parameters.

### Separation Between Moving Objects

The moving objects need to be reasonably separated in the field-of-view (FOV) or the ROI for best performance. This factor is very critical here since the image or video frame available to us only provides a 2D perspective view of the objects. (can be overcome provided the camera resolution allows the estimation of shade/depth and hence the 3D information of objects which is beyond the scope of this algorithm). Further the object position estimation/prediction performed by further modules (that could be depending on the above algorithm) such as the object tracker works best with a minimum separation of 3 pixels between the object contours or boundaries to differentiate objects as separate, or else would result in merging of tracks. Such merged objects could get classified wrongly in further analysis, owing to the indefinite shape and size as many shape features used on the OC algorithm could result in relatively wrong values.

### Speed of Moving Objects

The average speed of moving objects is desirably reasonably high and consistent for successful video motion detection. Problems that occur due to speed of object most visibly impact both indoor and outdoor scenarios. Any object moving at very low speed (usually near-field cases in indoor and far-field cases in outdoor) could cause split motion blobs resulting in multiple track IDs for the same object followed by erroneous classification due to lack of shape information. On the other hand, any object moving at very high speed may not be available in the frame/ROI for sufficiently long duration to be assigned a track ID and may pose problems to further processing such as classification. The dependency can also be viewed from another perspective—the frame rate perspective. If the video frame capture rate is very low (less than 5 fps) even slow moving objects will tend to stay for a very short duration within the scene, while very high capture rate (greater than 20 fps) would result in slow moving objects being learnt as BGND hence would go undetected. It is therefore suggested to use a capture rate of 5 to 15 fps for best results.

### Minimum Object Size (MOS)

The MOS (specified as the count of FGND pixels for a given moving object) is in some embodiments among the most critical factors to ensure best performance. The MOS is one of the primary aspects of any scene and any object. The MOS setting assumes bigger proportions due to the fact that all pixels on the body of the object need not necessarily show perceivable motion information. This would lead to the fact that on an average, 75% to 90% of the object pixels only get represented in the motion segmented result. Coupled to this, far-field and near-field scenarios add further dimensions of variation to the existence and definition of the object in the motion map (binary representation of the FGND and BGND). There exist further complications that could arise due to the visible fact that a vehicle such as a car moving at far-field location could result in the same binary map as a human at near-field location. Also, a smaller MOS could be sufficient for allowing the establishment of a track while, the same MOS would prove insufficient for any classifier to properly estimate the shape information. MOS also doubles-up as a very useful factor to filter out false motion due to snow, rain etc. Owing to all these facts and in view of the enormity of the impact of MOS, it is strongly suggested to approach the problem from the optical perspective to decide the most appropriate MOS. The MOS in the current version has been fixed separately for outdoor and indoor scenarios. But it is to be noted that depending on the nature of mounting the camera, both outdoor and indoor scenes could have far-field and near-field cases in many situations. Hence it would be most appropriate to derive the MOS based on the following parameters available to us:
1. Camera CCD resolution (obtained from the camera user manual)
2. Camera focal length (obtained from the camera user manual)
3. Frame Capture Resolution (CIF/QCIF/4CIF etc.)
4. Vertical distance (height) of camera placement
5. Horizontal distance of the farthest point in the FOV under surveillance (Refer to Notes at the end of this section)
6. Assumed typical height and width of humans and vehicles.

Using the above factors the MOS-Height and MOS-Width can be computed separately as shown in the sample computation below (sample MOS-Height for a typical “Human” object for an outdoor scenario)

### Sample Minimum Object Size Calculation for Human Height (MOS)

| | |
|---|---|
| Camera type: | SSC-DC393 |
| Image device: | ⅓ type Interline Transfer |
| | Exwave HAD CCD |
| Picture elements (H × V): | 768 × 494 |
| Sensing area: | ⅓″ format (4.8 × 3.6 mm) |
| Signal system: | NTSC standard |
| Horizontal resolution: | 480 TV lines |
| Focal Length | 8 mm (f) |

Total field of view (FOV) can be calculated using the relation 2 tan⁻¹(d/2f) z,1 Vertical FOV=2 tan⁻¹(3.6/2×8), i.e., Vertical FOV=25.36 degress
Or in other words, Vertical FOV=25⁰ degrees and 21 “minutes, 36 seconds
No. of Vertical Pixels on CCD=494
I_FOV (vertical)=25.36/494
I_FOV=0.05134 degrees
Let the object's vertical size is say 6 feet (for Human)=X
Camera to Object Range=R=Sqrt[(horizontal distance)²+(Vertical distance)²]
Angle subtended by the object at camera (theta)=(X/R×180/Pi) degrees =(6/82.5)×(180/3.14)X
Therefore, θ=4.16⁰
No. of pixels occupied by the object along the vertical axis is =θ/I_FOV =4.16/0.05134=81 pixels

Hence the MOS for Human-Height in this case will be approximately 81 pixels. Similarly, the MOS for Human Width, for the same Human sample object turns out to be approximately 31 pixels. Application of these values individually to the object height and width would enable better filtering. It is to be noted here that actual MOS-Height and MOS-Width could be a percentage (approximately 70%) of the theoretical value for best results. Note this calculation does not give the actual MOS (actual pixels on the object body) but it gives the pixel values corresponding to the MBR enclosing the object. Hence a percentage of these values could actually be considered for application rather than the computed values which are too large.

### Guidelines on Setting Correct Camera Field of View and Marking Region of Interest

The camera FOV setup and ROI selection should be done with care for best performance and results. The camera is desirably located/mounted in such a manner as to satisfy the following criteria with respect to the FOV (and hence the ROI):

1. FOV should be centered (w.r.t. the video frame) as far as possible

2. FOV should include majority of the location or extent of the scene to be monitored

3. FOV should be focused correctly by adjusting the camera focal length for best viewing

4. FOV should include the farthest/nearest locations to be monitored in the scene

5. Object skew due to camera orientation should be avoided within the FOV

6. Place the camera as high as possible in Indoor locations for good FOV

7. Place the camera as low as permissible in Outdoor locations for good FOV

8. Avoid camera placement at corners/under roofs in Indoor locations for good FOV

9. FOV should avoid containing thick poles or pillars (to avoid split objects)

10. FOV should contain as less static moving objects such as Trees/Small Plants

11. FOV should exclude places which could contribute to intermittent object stoppages

12. FOV should avoid very thick shadows to help clear object exposure to the camera

13. FOV should try to avoid reflecting surfaces to the extent possible

14. Avoid placement of camera in narrow passages (rather place camera at exit/entrance)

15. FOV should avoid elevator doors, stairs, escalators, phone booths wherever possible

16. Avoid placement of camera opposite to reflecting surfaces and bright corners.

17. As far as possible avoid placing the outdoor camera towards East and West directions

18. FOV should avoid regions of continuous motion such as rivers etc. (except far-field)

19. FOV should avoid freeways/motorways/expressways unless deliberately required

20. Only far-field FOV's should be allowed to contain corners of roads/walkways

The ROI drawn by the user has a complete relevance to the FOV and could either supplement or complement the FOV as per the scenario under consideration. Hence ROI's too should be drawn or selected based on the above criteria. On the other hand, user defined regular/irregular ROI's are a very effective means of deriving the best performance of the algorithms by avoiding regions in the FOV that could result in object occlusion, object split, object merge with BGND (dark corners/thick shadows) etc. Also care should be exercised while installing and configuring cameras at busy locations such as shopping malls, airport lobbies, indoor parking lots, airport car rentals/pick-up locations etc.

### Experimental Results

The example algorithm presented above is highly robust in rejecting false motion created due to various extraneous events such as those listed below. Unwanted motion created due to moving shadows of clouds across the region under surveillance is ignored—the effects of such variations are learnt very fast by the algorithm (approximately within 10 to 15 frames or within 2 to 3 seconds of the advent of the cloud shadow). In any case these initial motion blobs would be ignored or rendered redundant by the tracker.

All moving objects which pass below existing broad/frame-spanning shadows cast due to large stationary bodies in the scene such as buildings/tall trees, are reliably detected since such shadows are well learnt by the algorithm. Unwanted/Pseudo-motion created due to falling snow/rain is completely rejected by instantaneous learning of BGND, due to the continuously adaptive learning parameter “ALPHA”. Unwanted tree motion caused due to low and moderate breeze/winds will be slowly learnt. However, any motion blobs that are created due to such motion, would be filtered due to the application of the MOS criteria or would be eliminated in the tracker due to the inconsistency of the track association. Shadows with low brightness, and the shadows that are thin are NOT detected as motion regions due to the dependence of the global BGND threshold on the average variance of the frame.

### Conclusion

The examples presented here illustrate by way of example algorithms and embodiments how video motion detection can be improved to provide better detection of moving objects, and better discrimination between a moving object and other environmental occurrences such as shadows, weather, or a slowly changing background. Extracting color information to estimate regions of motion in two or more sequential video frames, and extracting edge information to estimate object shape of the moving object in two or more sequential video frames enables combining the color information and edge information to estimate motion of the object more robustly than was possible with previous technologies.

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the example embodiments of the invention described herein. It is intended that this invention be limited only by the claims, and the full scope of equivalents thereof.

1. A method to detect a moving object in a video data stream, comprising:
extracting color information to estimate regions of motion in two or more sequential video frames
extracting edge information to estimate object shape of the moving object in two or more sequential video frames; and
combining the color information and edge information to estimate motion of the object.

2. The method of claim 1, further comprising extracting contrast information from two or more sequential video frames, and combining the extracted contrast information with the color information and edge information in estimating motion of the object.

3. The method of claim 1, wherein combining the color information and edge information comprises correlating the information to estimate the position and motion of the object.

4. The method of claim 1, further comprising updating a learned background image record using the color information and edge information.

5. The method of claim 1, wherein the video stream comprises video frames at a frame rate between and including five to twenty frames per second.

6. The method of claim 1, wherein information is extracted to estimate motion in only a selected region of interest in the video data stream.

7. A video monitoring system, comprising:
a video signal interface operable to receive a video signal from a camera;
a video processing module operable to analyze the received video signal, the analysis comprising:
extracting color information to estimate regions of motion in two or more sequential video frames
extracting edge information to estimate object shape of the moving object in two or more sequential video frames; and
combining the color information and edge information to estimate motion of the object.

8. The video monitoring system of claim 7, the received video signal analysis further comprising extracting contrast information from two or more sequential video frames, and combining the extracted contrast information with the color information and edge information in estimating motion of the object.

9. The video monitoring system of claim 7, wherein combining the color information and edge information comprises correlating the information to estimate the position and motion of the object.

10. The video monitoring system of claim 7, the received video signal analysis further comprising using the color information and edge information to update a learned background image record.

11. The video monitoring system of claim 7, wherein the video stream comprises video frames at a frame rate between and including five to twenty frames per second.

12. The video monitoring system of claim 7, wherein information is extracted to estimate motion in only a selected region of interest in the video data stream.

13. A machine-readable medium with instructions stored thereon, the instructions when executed operable to cause a computerized system to:
extract color information to estimate regions of motion in two or more sequential video frames
extract edge information to estimate object shape of the moving object in two or more sequential video frames; and
combine the color information and edge information to estimate motion of the object.

14. The machine-readable medium of claim 13, the instructions when executed further operable to cause the computerized system to extract contrast information from two or more sequential video frames, and combining the extracted contrast information with the color information and edge information in estimating motion of the object.

15. The machine-readable medium of claim 13, wherein combining the color information and edge information comprises correlating the information to estimate the position and motion of the object.

16. The machine-readable medium of claim 13, the instructions when executed further operable to cause the computerized system to update a learned background image record using the color information and edge information.

17. The machine-readable medium of claim 13, wherein the video stream comprises video frames at a frame rate between and including five to twenty frames per second.

18. The machine-readable medium of claim 13, wherein information is extracted to estimate motion in only a selected region of interest in the video data stream.
